(19) United States
(12) Patent Application Publication
(10) Pub. No.: US 2013/0243312 A1
(43) Pub. Date: Sep. 19, 2013

(54) COLOR DISTANCE MEASUREMENT APPARATUS, COLOR DISTANCE MEASUREMENT METHOD, AND PROGRAM

(71) Applicant: SONY CORPORATION, Tokyo (JP)

(72) Inventor: Yoichiro Sato, Tokyo (JP)

(73) Assignee: Sony Corporation, Tokyo (JP)

(21) Appl. No.: 13/779,078

(22) Filed: Feb. 27, 2013

(30) Foreign Application Priority Data
Mar. 14, 2012 (JP) 2012-056602

(51) Int. Cl. G06T 7/00

(52) U.S. Cl. CPC G06T 7/0089
USPC 382/164

(57) ABSTRACT

A color distance measurement apparatus includes: a first transformation section that transforms first color pixel data and second color pixel data in a predetermined color space into a deformed HSV color space; a second transformation section that transforms the first color pixel data and the second color pixel data transformed into the deformed HSV color space into a three-dimensional x, y, z coordinate representation; and a color distance measurement section that measures a relative color distance between the first color pixel data and the second color pixel data on the basis of the first color pixel data and the second color pixel data transformed into the x, y, z coordinate representation. In the deformed HSV color space, maximum saturation is larger than maximum saturation in an HSV color space for a cone model at lightness between maximum lightness and minimum lightness, and the saturation is 0 at the minimum lightness.

### BACKGROUND

The present technology relates to a color distance measurement apparatus, a color distance measurement method, and a program, and in particular to a color distance measurement apparatus, a color distance measurement method, and a program for use in processes such as color similarity map generation and image segmentation.

Processes for measuring a relative color distance are fundamental to a variety of image processing including image recognition, high-quality filtering, and image compression and expansion. In the field of image segmentation and visual saliency extraction, in particular, a relative color distance is calculated for pixels of an input image to segment the image into regions of similar colors or to detect salient regions. For example, SLIC Superpixels, EPFL Technical Report no. 149300 published in June 2010 by Radhakrishna Achanta, Appu Shaji, Kevin Smith, Aurelien Lucchi, Pascal Fua, and Sabine Susstrunk describes a technology for measuring a relative color distance to perform image segmentation.

### SUMMARY

In calculating a relative color distance, a CIE LAB (CIE 1976, hereinafter referred to as “LAB color space”) that enables calculation of a color distance comparable to that obtained through human color perception is most commonly used as taught in the SLIC Superpixels, EPFL Technical Report no. 149300 mentioned above. With the LAB color space, however, a large amount of computation is performed for transformation, and real-time processing may be difficult for small digital signal processors (DSPs) for use in mobile devices such as digital cameras and smartphones with a camera.

For example, transformation from an RGB (Rec. 709 (D65)) color space into the LAB color space is performed in two stages, namely transformation from RGB into XYZ and transformation from XYZ into CIE LAB. The following formulas (1) represent the transformation from RGB into XYZ. The following formulas (2) represent the transformation from XYZ into CIE LAB.

$$\begin{matrix}X = 0.4124 R + 0.3576 G + 0.1805 B \\ Y = 0.2126 R + 0.7152 G + 0.0722 B \\ Z = 0.0193 R + 0.1192 G + 0.9505 B \\ {x}_{r} = X \text{/} {X}_{r} \\ {y}_{r} = Y \text{/} {Y}_{r} \\ {z}_{r} = Z \text{/} {Z}_{r} \\ {f}_{x} = \{ \begin{matrix}\sqrt[3]{{x}_{r}} & {x}_{r} > 0.008856 \\ ( 903.3 {x}_{r} + 16 ) \text{/} 116 & {x}_{r} \leq 0.008856\end{matrix} \\ {f}_{y} = \{ \begin{matrix}\sqrt[3]{{y}_{r}} & {y}_{r} > 0.008856 \\ ( 903.3 {y}_{r} + 16 ) \text{/} 116 & {y}_{r} \leq 0.008856\end{matrix} \\ {f}_{z} = \{ \begin{matrix}\sqrt[3]{{z}_{r}} & {z}_{r} > 0.008856 \\ ( 903.3 {z}_{r} + 16 ) \text{/} 116 & {z}_{r} \leq 0.008856\end{matrix} & ( 1 ) \\ L = 116 \times {f}_{y} - 16 \\ A = 500 \times ( {f}_{x} - {f}_{y} ) \\ B = 200 \times ( {f}_{y} - {f}_{z} ) & ( 2 )\end{matrix}$$

If a relative color distance is measured using YCbCr or RGB, which is the most common color space, in an environment where computation with the LAB color space is difficult, the derived relative color distance may deviate from the human color perception or be unbalanced. For example, only a difference in brightness Y in the YCbCr color space may be emphasized, or only a difference in G in the RGB color space is emphasized.

Measurement of a color distance in an HSV color space, which is expected to represent a color space similar to the human color perception compared to YCbCr and RGB, is considered. With the normal HSV color space (hue H, saturation S, and lightness V), it is difficult to define a relative color distance using a single index, because the hue H is a rotational component in contrast to the saturation S and the lightness V which are each a scale component whose value itself represents a distance. FIG. 8A shows an HSV color space for a cone model. FIG. 8B shows an HSV color space for a column model.

As the simplest way to represent a color distance using a single index in the HSV color space, it is conceivable to transform a color space having an angular representation of the hue H into a three-dimensional Euclidean x, y, z coordinate representation to represent a relative color distance as a Euclidean distance. In this event, it is necessary to select a cone model (see FIG. 9A) or a column model (see FIG. 9B) for the HSV color space.

In measuring a relative color distance in the HSV color space using a cone model, the maximum value of the saturation S becomes smaller as the lightness V is closer to 0, which reduces color separation performance. Thus, the relative color distance tends to be determined to be shorter as the input image has lower lightness. For example, if image segmentation is performed on the basis of the Euclidean distance in the HSV color space measured using a cone model, objects at low lightness may not be segmented.

In measuring a relative color distance in the HSV color space using a column model, in contrast, the saturation S is maintained at a constant maximum value even if the lightness V becomes close to 0. Therefore, if a distance in the HSV color space measured using a column model is measured, a distance with a considerable value may be output even for colors that humans would perceive to be identically black. For example, if image segmentation is performed on the basis of the Euclidean distance in the HSV color space measured using a column model, a black object at low lightness that humans would determine to be solid may be segmented into a plurality of different objects because color separation performance for black is too high.

Thus, measuring a relative color distance in the HSV color space on the basis of the Euclidean distance may cause a problem with color separation performance at low lightness, whether a cone model or a column model is used.

It is desirable to measure a relative color distance to achieve good results.

According to an embodiment of the present technology, there is provided a color distance measurement apparatus including: a first transformation section that transforms first color pixel data and second color pixel data in a predetermined color space into a deformed HSV color space; a second transformation section that transforms the first color pixel data and the second color pixel data, which have been transformed into the deformed HSV color space, into a three-dimensional x, y, z coordinate representation; and a color distance measurement section that measures a relative color distance between the first color pixel data and the second color pixel data on the basis of the first color pixel data and the second color pixel data which have been transformed into the x, y, z coordinate representation, in which in the deformed HSV color space, a maximum value of saturation is larger than a maximum value of saturation in an HSV color space for a cone model at lightness between maximum lightness and minimum lightness, and the saturation is 0 at the minimum lightness.

In the embodiment of the present technology, the first transformation section transforms first color pixel data and second color pixel data in a predetermined color space into a deformed HSV color space. In addition, the second transformation section transforms the first color pixel data and the second color pixel data, which have been transformed into the deformed HSV color space, into a three-dimensional x, y, z coordinate representation. Then, the color distance measurement section measures a relative color distance between the first color pixel data and the second color pixel data on the basis of the first color pixel data and the second color pixel data which have been transformed into the x, y, z coordinate representation.

In the deformed HSV color space, a maximum value of saturation is larger than a maximum value of saturation in an HSV color space for a cone model at lightness between maximum lightness and minimum lightness, and the saturation is 0 at the minimum lightness.

According to the embodiment of the present technology, a relative color distance is measured in the deformed HSV color space as a Euclidean distance. Thus, it is possible to avoid a problem with color separation performance at low lightness when a cone model or a column model is used, and to reduce the amount of computation compared to a case where a relative color distance is measured in the deformed HSV color space.

In another embodiment of the present technology, for example, the maximum value of the saturation at each lightness in the deformed HSV color space may be determined such that a color distance between two colors having different saturations at the same lightness measured in the deformed HSV color space is equal to a color distance between the two colors measured in an LAB color space. With the maximum value of the saturation at each lightness in the deformed HSV color space determined in this way, the calculated relative color distance may be approximated to a relative color distance calculated in the LAB color space which enables calculation of a relative color distance comparable to that obtained through human color perception.

The color distance measurement apparatus according to still another embodiment of the present technology may further include, for example, a control section that controls a synthesis ratio at which the color distance measurement section mixes a distance based on hue and saturation components and a distance based on a lightness component. For example, the first color pixel data may include pixel data on a specific pixel forming an image, the second color pixel data may include pixel data on an arbitrary pixel forming the image, and the control section may control the synthesis ratio on the basis of average lightness for the image and lightness for an area around the specific pixel. In this case, for example, the image may be an image captured by an imaging element. With the synthesis ratio controlled in this way, it is possible to consider a distance in hue and saturation and a distance in lightness separately from each other.

The color distance measurement apparatus according to yet another embodiment of the present technology may further include, for example, a data table that stores a maximum value of saturation at predetermined sampling points of lightness in the deformed HSV color space, and the first transformation section may transform the first color pixel data and the second color pixel data in the predetermined color space into the deformed HSV color space using the data table. Providing the data table may reduce the amount of computation performed to transform the first color pixel data and the second color pixel data in the predetermined color space into the deformed HSV color space. The maximum value of the saturation corresponding to lightness between the sampling points may be calculated through interpolation.

According to an embodiment of the present technology, it is possible to measure a relative color distance to achieve good results.

### BRIEF DESCRIPTION OF THE DRAWINGS

FIG. 1 is a block diagram showing an exemplary configuration of a digital camera according to an embodiment.

FIGS. 2A and 2B illustrate operation of the digital camera.

FIG. 3 is a block diagram showing an exemplary configuration of a subject extraction section of the digital camera.

FIG. 4 schematically shows a deformed HSV color space.

FIG. 5 shows the relationship in relative color distance between pixel data A and B for two colors at certain lightness V in the deformed HSV color space.

FIG. 6 is a flowchart showing procedures for a process corresponding to deformed HSV/three-dimensional coordinate transformation sections and a color distance measurement section of the subject extraction section.

FIG. 7 is a block diagram showing another exemplary configuration of the subject extraction section of the digital camera.

FIGS. 8A and 8B show an HSV color space for a cone model and an HSV color space for a column model, respectively.

FIGS. 9A and 9B illustrate transformation of the HSV color space for a cone model and the HSV color space for a column model, respectively, into a three-dimensional Euclidean x, y, z coordinate representation.

### DETAILED DESCRIPTION OF EMBODIMENTS

An embodiment of the present disclosure will be described below. The description will be made in the following order.

1. Embodiment

2. Modification

### 1. Embodiment

[Exemplary Configuration of Digital Camera]

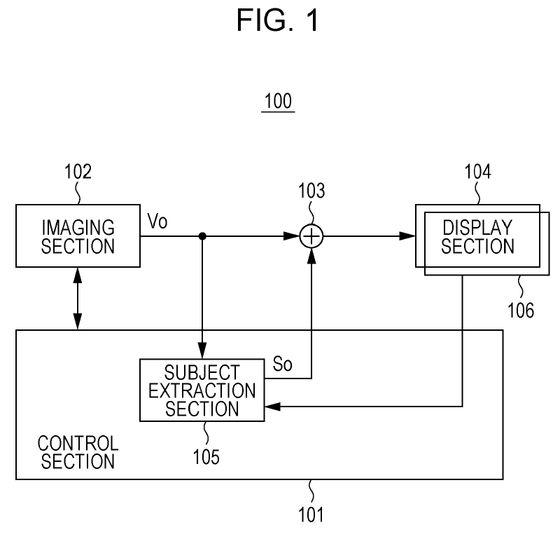

FIG. 1 shows an exemplary configuration of a digital camera 100. In the exemplary configuration, for simplicity of illustration, a system for recording and regenerating image data is not shown. The digital camera 100 includes a control section 101, an imaging section 102, a synthesis section 103, and a display section 104.

The control section 101 includes a CPU, a ROM, a RAM, etc. (not shown), and controls operation of various components of the digital camera 100. The control section 101 includes a subject extraction section 105. The subject extraction section 105 extracts a specific subject in an image specified by a user by operating a touch panel to be discussed later on the basis of an image signal Vo output from the imaging section 102, and generates a frame display signal So for displaying a rectangular frame surrounding the subject.

The imaging section 102 may be a charge coupled device (CCD) imager, a complementary metal oxide semiconductor (CMOS) imager, etc., for example. The imaging section 102 performs sample and hold control, gain control, analog-digital conversion, white-balance adjustment, gamma correction, etc. on a signal obtained by the imager to output an image signal Vo corresponding to a captured image.

The synthesis section 103 mixes the frame display signal So output from the subject extraction section 105 with the image signal Vo output from the imaging section 102. The display section 104 may be a liquid crystal display element, an organic electro-luminescence (EL) display element, etc. The display section 104 is driven in accordance with an image signal output from the synthesis section 103 to display an image based on the image signal.

A touch panel 106 is disposed on a display screen of the display section 104. The user may touch the touch panel 106 to specify a specific subject on the image displayed on the display section 104. The touch panel 106 outputs a position specifying signal for specifying the position of the specific subject specified by the user to the subject extraction section 105 of the control section 101.

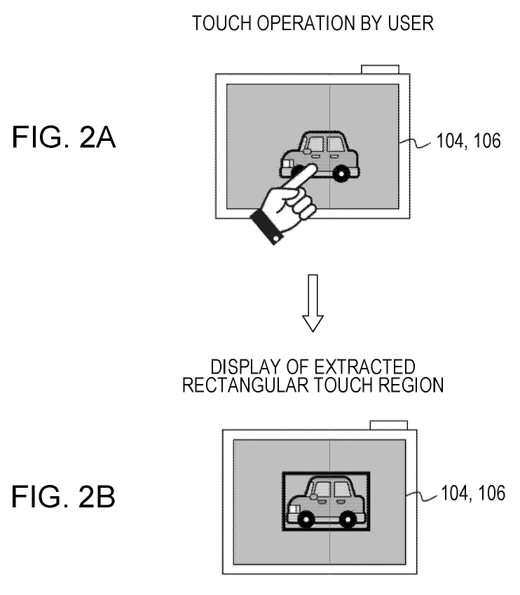

Operation of the digital camera 100 shown in FIG. 1 will be described briefly. The image signal Vo obtained by the imaging section 102 by capturing an image is supplied to the display section 104 via the synthesis section 103. The display section 104 displays an image based on the image signal Vo as shown, for example, in FIG. 2A. In the example shown, an automobile is captured as a subject.

In this display state, the user touches a point corresponding to the automobile on the touch panel 106 to specify the automobile as the specific subject on the displayed image. In this case, a position specifying signal for specifying the position of the automobile on the image is output from the touch panel 106 to be sent to the subject extraction section 105.

The subject extraction section 105 performs a process for extracting the automobile as the subject on the basis of the image signal Vo output from the imaging section 102 and the position specifying signal output from the touch panel 106. As discussed in detail later, the extraction process is performed by measuring the relative color distance between pixel data at the position of the image specified by the user and data for each pixel forming the image to prepare a color similarity map. As a result of the extraction process, the subject extraction section 105 generates, for each frame of the image signal Vo, a frame display signal So for displaying a rectangular frame surrounding the automobile.

The frame display signal So output from the subject extraction section 105 of the control section 101 is supplied to the synthesis section 103 to be mixed with the image signal Vo output from the imaging section 102. Then, an image signal mixed with the frame display signal So is supplied to the display section 104. The display section 104 displays an image including the automobile surrounded by a frame as shown in FIG. 2B. The frame display signal So output from the subject extraction section 105 is updated for each frame. Therefore, the frame surrounding the automobile is moved along with movement of the automobile so as to follow the automobile.

[Exemplary Configuration of Subject Extraction Section]

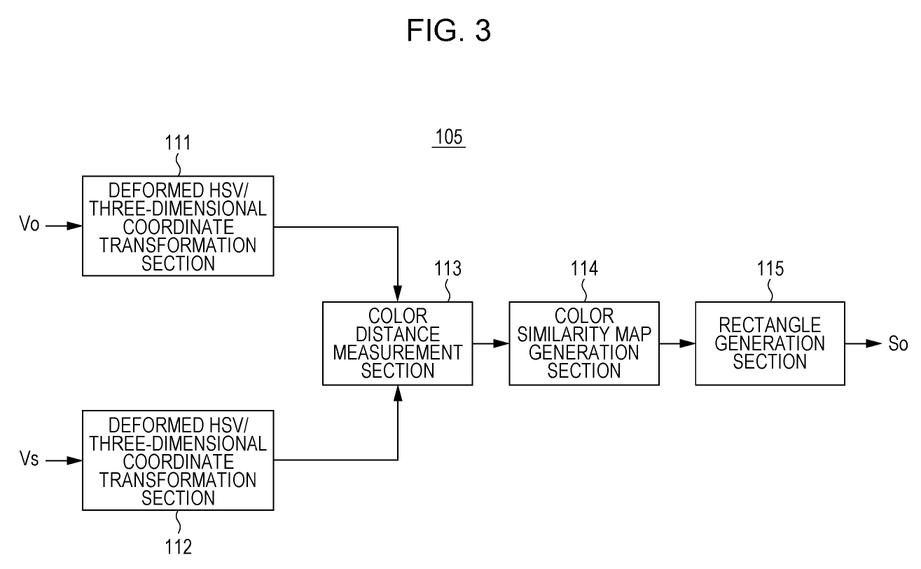

Next, an exemplary configuration of the subject extraction section 105 will be described. FIG. 3 shows an exemplary configuration of the subject extraction section 105. The subject extraction section 105 includes deformed HSV/three-dimensional coordinate transformation sections 111 and 112, a color distance measurement section 113, a color similarity map generation section 114, and a rectangle generation section 115.

The deformed HSV/three-dimensional coordinate transformation section 111 receives as an input the image signal Vo output from the imaging section 102 (see FIG. 1). The image signal Vo includes pixel data in a common color space such as an RGB color space or a YCbCr color space, for example. The deformed HSV/three-dimensional coordinate transformation section 111 performs a process for transforming the pixel data into a deformed HSV color space for each frame of the image signal Vo. For example, if the image signal Vo is a full-HD image signal, the image signal Vo for one frame includes data for 1920×1080 pixels. In addition, the deformed HSV/three-dimensional coordinate transformation section 111 further transforms the pixel data which have been transformed into the deformed HSV color space into a three-dimensional x, y, z coordinate representation.

The deformed HSV/three-dimensional coordinate transformation section 112 receives as an input pixel data Vs extracted from the pixel data for each frame of the image signal Vo and corresponding to a touch point at the time when the user touches the touch panel 106. The deformed HSV/three-dimensional coordinate transformation section 112 performs a process for transforming the pixel data Vs into a deformed HSV color space. In addition, the deformed HSV/three-dimensional coordinate transformation section 112 further transforms the pixel data Vs which have been transformed into the deformed HSV color space into a three-dimensional x, y, z coordinate representation.

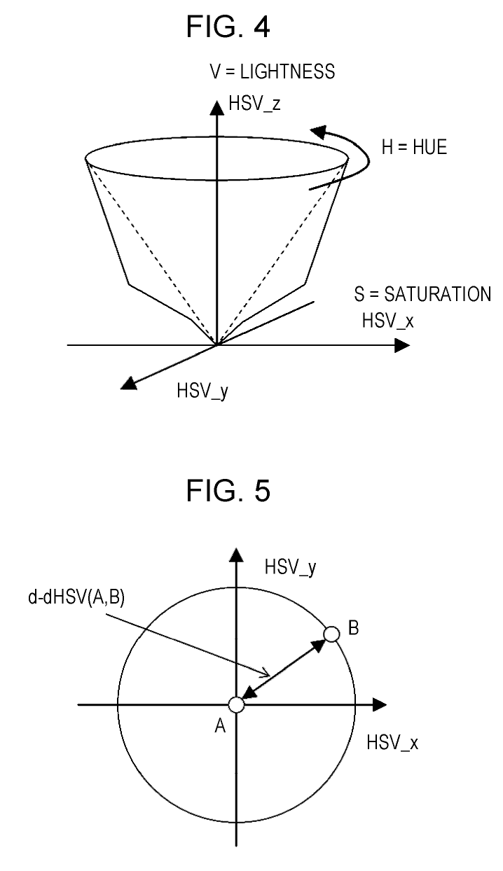

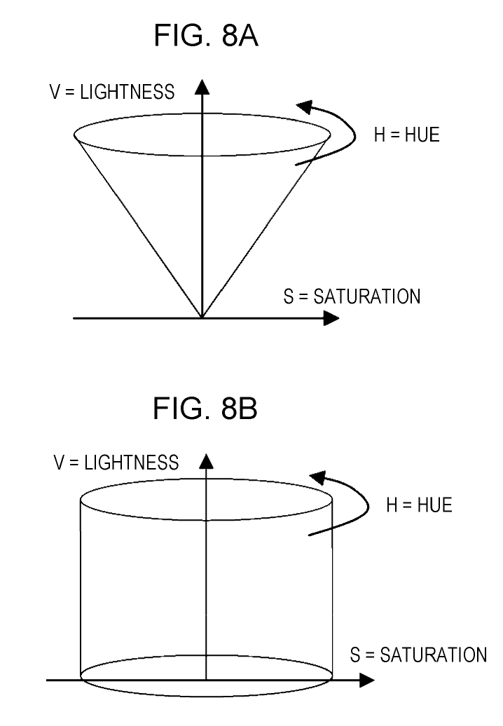

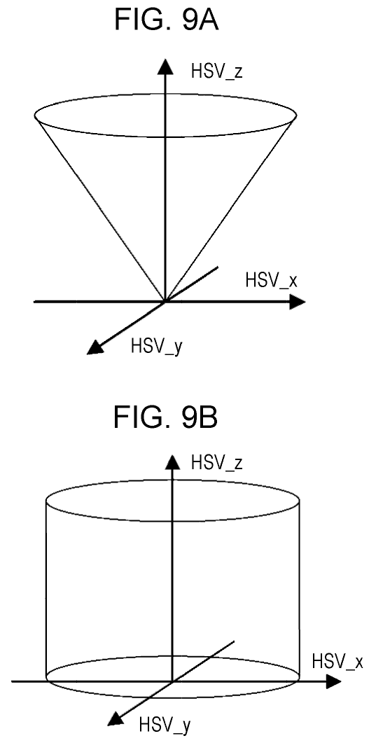

The deformed HSV color space is obtained by modulating the saturation in the HSV color space at low lightness to represent a color distance close to the human perception using a three-dimensional Euclidean distance. FIG. 4 schematically shows the deformed HSV color space. In the deformed HSV color space, the maximum value of the saturation is larger than the maximum value of the saturation (indicated by the broken line in FIG. 4) in the HSV color space for a cone model (see FIGS. 8A and 9A) at lightness between the maximum lightness and the minimum lightness, and the saturation is 0 at the minimum lightness.

For example, when the maximum value and the minimum value of the three RGB elements are defined as MAX and MIN, respectively, the hue H, the saturation S, and the lightness V in the deformed HSV color space are indicated by the following formulas (3):

$$V = MAX$$

$$H = \{ \begin{matrix}60 \times \frac{G - B}{MAX - MIN} , & if MAX = R \\ 60 \times \frac{B - R}{MAX - MIN} + 120 , & if MAX = G \\ 60 \times \frac{R - G}{MAX - MIN} + 240 , & if MAX = B\end{matrix} \\ \begin{matrix}S = \frac{MAX - MIN}{MAX} \times f ( V ) & ( 3 )\end{matrix}$$

Among the hue H, the saturation S, and the lightness V in the deformed HSV color space, the hue H is a rotational angle, and the saturation S and the lightness V are each a scale component. Therefore, a relative color distance may not be represented by a single index. Thus, it is considered to measure a relative color distance after the H, S, and V components are transformed into a three-dimensional Euclidean x, y, z coordinate representation as discussed above. Therefore, the deformed HSV/three-dimensional coordinate transformation sections 111 and 112 transform the pixel data Vs which have been transformed into the deformed HSV color space into a three-dimensional x, y, z coordinate representation as discussed above.

The following formulas (4) indicate transformation of the H, S, and V components into an x, y, z coordinate representation.

hsvₓ=S×cos(H)

hsv_{y}=S×sin(H)

hsv_{z}=V (4)

The saturation S in the deformed HSV color space is a function of the lightness V. f(V) represents the maximum amount of deformation in the direction of the saturation in the deformed HSV color space, that is, the maximum value of the saturation. If the image before transformation is an 8-bit RGB image, the lightness V is in the range of 0 to 255. Therefore, f(V) has a value from a table with 256 elements. The deformed HSV/three-dimensional coordinate transformation sections 111 and 112 include a data table (not shown) with table values for 256 elements or for predetermined extracted sampling points, and read a value of f(V) corresponding to the lightness V from the data table to use the read value. For a value of the lightness V removed as a result of the extraction, the deformed HSV/three-dimensional coordinate transformation sections 111 and 112 generate a value of f(V) through interpolation based on values of f(V) at lightness V close to the removed value of the lightness V. If the data table has table values for only extracted sampling points, the volume of the table may be reduced.

An example of a method of obtaining f(V) will be described. It is assumed that the most versatile shape of a deformed HSV color space is such a shape that minimizes the difference between a color distance obtained in the deformed HSV color space and a color distance obtained in the LAB color space. Then, a color distance between pixel data A and B for two arbitrary colors is calculated for both the deformed HSV color space and the LAB color space, and f(V) that minimizes the difference between the color distances is considered to provide the most versatile shape that is the closest to the human perception.

For simplification, it is considered that the pixel data A and B for two colors have the same lightness (V or hsv_z), and that the distance in hue and saturation (H and S or hsv_x and hsv_y) is to be minimized. That is, f(V) is determined such that the relative color distance on a plane defined by the hue and the saturation in the deformed HSV color space (hsv_x-hsv_y plane) at the same brightness approximates the relative color distance in the LAB color space.

FIG. 5 shows the relationship in relative color distance between the pixel data A and B for two colors at certain lightness V in the deformed HSV color space. For further simplification, the pixel data A for one of the colors is achromatic at all times. At this time, the relative color distance d-dHSV(A,B) equals the saturation S−B of the pixel data B for the other color as indicated by the following formula (5):

$$\begin{matrix}d \text{-} dHSV ( A , B ) = \sqrt{{( hsv \text{-} xA - hsv \text{-} xB )}^{2} + {( hsv \text{-} yA - hsv \text{-} yB )}^{2}} \\ = \sqrt{{( {S}_{A} cos {H}_{A} - {S}_{B} cos {H}_{B} )}^{2} + {( {S}_{A} sin {H}_{A} - {S}_{B} sin {H}_{B} )}^{2}} \\ = S \text{-} B\end{matrix} \qquad ( 5 )$$

Next, the relative color distance d-Lab(A,B) between the pixel data A and B for two colors in the LAB color space is calculated as indicated by the following formula (6). Therefore, if the relative color distances in the deformed HSV color space and the LAB color space are equal to each other, S−B may be represented by the following formula (7).

d-Lab(A,B)=\sqrt{(L_{A}−L_{B})²+(a_{A}−a_{B})²+(b_{A}−b_{B})²} (6)

S−B=d−Lab(A,B) (7)

If the pixel data B have the maximum saturation value at lightness V, the value of S−B itself equals f(V) that determines the shape of the deformed HSV color space at lightness V. f(V) is finally determined as the average of values of S−B calculated for the pixel data B for a plurality of sample colors (colors having the maximum saturation value at lightness V).

Returning to FIG. 3, the color distance measurement section 113 sequentially acquires, for each frame of the image signal Vo, pixel data forming that frame as first color pixel data, and measures a relative color distance between the first color pixel data and the pixel data Vs serving as second color pixel data. In this event, as discussed above, the relative color distance is measured as a Euclidean distance using the first color pixel data which have been transformed into an x, y, z coordinate representation by the deformed HSV/three-dimensional coordinate transformation section 111 and the second color pixel data which have been transformed into an x, y, z coordinate representation by the deformed HSV/three-dimensional coordinate transformation section 112.

When the x, y, z coordinate representation of the first color pixel data is (hsv-xA, hsv-yA, hsv-zA) and the x, y, z coordinate representation of the second color pixel data is (hsv-xB, hsv-yB, hsv-zB), the relative color distance d may be represented by the following formulas (8), (9), (10), etc. The formula (8) derives a distance based on a first-order norm. The formula (9) derives a distance based on a second-order norm. The formula (10) derives a distance based on the square root of a second-order norm.

$$\begin{matrix}d = \vert hsv \text{-} xA - hsv \text{-} xB \vert + \vert hsv \text{-} yA - hsv \text{-} yB \vert + \vert hsv \text{-} zA - hsv \text{-} zB \vert & ( 8 ) \\ d = \vert \vert hsv \text{-} xA - hsv \text{-} xB \vert \vert + \vert \vert hsv \text{-} yA - hsv \text{-} yB \vert \vert + \vert \vert hsv \text{-} zA - hsv \text{-} zB \vert \vert & ( 9 ) \\ d = \sqrt{\vert \vert hsv \text{-} xA - hsv \text{-} xB \vert \vert + \vert \vert hsv \text{-} yA - hsv \text{-} yB \vert \vert + \vert \vert hsv \text{-} zA - hsv \text{-} zB \vert \vert} & ( 10 )\end{matrix}$$

The relative color distance d may be basically calculated using the formula (8), the formula (9), and the formula (10) given above, etc. However, f(V) which represents the maximum value of the saturation S in the deformed HSV color space is determined such that the relative color distance on a plane defined by the hue and the saturation in the deformed HSV color space at the same brightness approximates the relative color distance in the LAB color space as discussed above, for example. In this case, the approximation in relative color distance between the deformed HSV color space and the LAB color space is not considered for the pixel data A and B for two colors at different lightnesses V.

Therefore, in this case, the distance in lightness V component and the distance in hue H and saturation S components should be considered separately in the deformed HSV color space. That is, in this case, the color distance measurement section 113 calculates a distance with weights assigned to the lightness V component and the hue H and saturation S components, and adjusts the weight wv for the lightness V component and the weight ws for the hue H and saturation S components in accordance with the purpose of use. In this case, the relative color distance d may be represented by the following formula (11), the formula (12), the formula (13), etc.

$$\begin{matrix}d = ws ( \vert hsv \text{-} xA - hsv \text{-} xB \vert + \vert hsv \text{-} yA - hsv \text{-} yB \vert ) + wv ( \vert hsv \text{-} zA - hsv \text{-} zB \vert ) & ( 11 ) \\ d = ws ( \vert \vert hsv \text{-} xA - hsv \text{-} xB \vert \vert + \vert \vert hsv \text{-} yA - hsv \text{-} yB \vert \vert ) + wv ( \vert \vert hsv \text{-} zA - hsv \text{-} zB \vert \vert ) & ( 12 ) \\ d = \sqrt{ws ( \vert \vert hsv \text{-} xA - hsv \text{-} xB \vert \vert + \vert \vert hsv \text{-} yA - hsv \text{-} yB \vert \vert ) + wv ( \vert \vert hsv \text{-} zA - hsv \text{-} zB \vert \vert )} & ( 13 )\end{matrix}$$

The color similarity map generation section 114 transforms, for each frame of the image signal Vo, a relative color distance di measured by the color distance measurement section 113 in correspondence with pixel data forming that frame into an image of an 8-bit gray-scale map. To this end, the color similarity map generation section 114 normalizes the relative color distance di into data from 0 to 255 as indicated by the following formula (14). Normalize( ) indicates a function for 0-255 normalization.

di′=Normalize(di), 0 to 255 (14)

After that, the color similarity map generation section 114 reverses, for each frame of the image signal Vo, normalized data di′ corresponding to pixel data forming that frame to generate color similarity map data di″. Reverse( ) indicates a function for 0-255 reversal.

di″=Reverse(di′) (15)

The rectangle generation section 115 uses a rectangle generation algorithm according to the related art on the basis of the color similarity map data di″ output from the color similarity map generation section 114 to generate a frame display signal So for displaying a rectangular frame surrounding the specific subject specified by the user on the image displayed on the display section 104.

Operation of the subject extraction section 105 shown in FIG. 3 will be described briefly. An image signal Vo obtained by the imaging section 102 (see FIG. 1) by capturing an image is input to the deformed HSV/three-dimensional coordinate transformation section 111. The deformed HSV/three-dimensional coordinate transformation section 111 transforms the pixel data into a deformed HSV color space for each frame of the image signal Vo (see the formulas (3)). Further, the deformed HSV/three-dimensional coordinate transformation section 111 transforms the pixel data which have been transformed into the deformed HSV color space into a three-dimensional x, y, z coordinate representation (see the formulas (4)).

Pixel data Vs extracted from the pixel data for each frame of the image signal Vo and corresponding to a touch point at the time when the user touches the touch panel 106 are input to the deformed HSV/three-dimensional coordinate transformation section 112. The deformed HSV/three-dimensional coordinate transformation section 112 transforms the pixel data Vs into a deformed HSV color space (see the formulas (3)). Further, the deformed HSV/three-dimensional coordinate transformation section 112 transforms the pixel data Vs which have been transformed into the deformed HSV color space into a three-dimensional x, y, z coordinate representation (see the formulas (4)).

The pixel data for each frame of the image signal Vo which have been transformed into an x, y, z coordinate representation by the deformed HSV/three-dimensional coordinate transformation section 111 are supplied to the color distance measurement section 113. The color distance measurement section 113 sequentially uses the pixel data as the first color pixel data. The pixel data Vs which have been transformed into an x, y, z coordinate representation by the deformed HSV/three-dimensional coordinate transformation section 112 are supplied to the color distance measurement section 113 as the second color pixel data. The color distance measurement section 113 measures the relative color distance d as a Euclidean distance using the first color pixel data which have been transformed into an x, y, z coordinate representation and the second color pixel data which have been transformed into an x, y, z coordinate representation (see the formulas (8) to (10) and (11) to (13)).

The relative color distance di measured by the color distance measurement section 113 for the pixel data for each frame of the image signal Vo is supplied to the color similarity map generation section 114. The color similarity map generation section 114 normalizes the relative color distance di for the pixel data for each pixel to obtain normalized data di′ (see the formula (14)). In addition, the color similarity map generation section 114 reverses the normalized data di′ to generate color similarity map data di″ (see the formula (15)).

The color similarity map data di″ for the pixel data for each frame of the image signal Vo generated by the color similarity map generation section 114 are supplied to the rectangle generation section 115. The rectangle generation section 115 generates, for each frame of the image signal Vo, a frame display signal So for displaying a rectangular frame surrounding the specific subject specified by the user on the basis of the color similarity map data di″ for the pixel data.

Consequently, the rectangle generation section 115 outputs a frame display signal So successively updated for each frame since the time when the user touches the touch panel 106 (see FIG. 2B). Thus, the frame displayed on the image displayed on the display section 104 (see FIG. 1) follows the specific subject specified by the user.

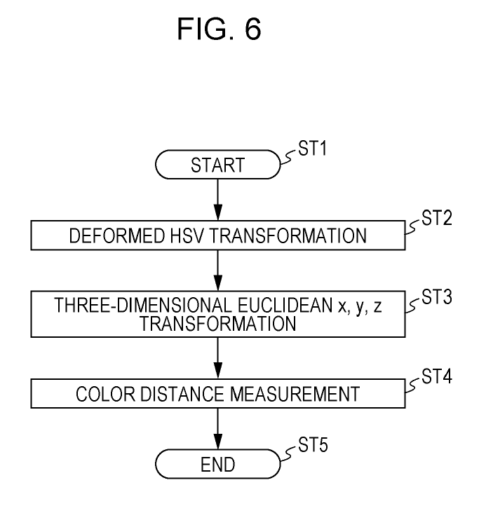

FIG. 6 is a flowchart showing procedures for a process corresponding to the deformed HSV/three-dimensional coordinate transformation sections 111 and 112 and the color distance measurement section 113 of the subject extraction section 105 shown in FIG. 3. In step ST1, the subject extraction section 105 starts the process, and then proceeds to step ST2.

In step ST2, the subject extraction section 105 performs deformed HSV transformation. That is, the deformed HSV/three-dimensional coordinate transformation section 111 transforms the pixel data into a deformed HSV color space for each frame of the image signal Vo. In addition, the deformed HSV/three-dimensional coordinate transformation section 112 transforms the pixel data Vs extracted from the pixel data for each frame of the image signal Vo and corresponding to a touch point at the time when the user touches the touch panel 106 into a deformed HSV color space.

Next, in step ST3, the subject extraction section 105 performs three-dimensional Euclidean x, y, z transformation. That is, the deformed HSV/three-dimensional coordinate transformation section 111 transforms the pixel data for each frame of the image signal Vo, which have been transformed into the deformed HSV color space, into a three-dimensional x, y, z coordinate representation. In addition, the deformed HSV/three-dimensional coordinate transformation section 112 transforms the pixel data Vs which have been transformed into the deformed HSV color space into a three-dimensional x, y, z coordinate representation.

Next, in step ST4, the subject extraction section 105 performs color distance measurement. That is, the color distance measurement section 113 successively acquires the pixel data for each frame of the image signal Vo, which have been transformed into an x, y, z coordinate representation by the deformed HSV/three-dimensional coordinate transformation section 111, as first color pixel data. Then, the color distance measurement section 113 measures the relative color distance d as a Euclidean distance using the first color pixel data and the pixel data Vs acquired as second color pixel data which have been transformed into an x, y, z coordinate representation by the deformed HSV/three-dimensional coordinate transformation section 112.

After step ST4, the subject extraction section 105 terminates the process in step ST5.

As discussed above, the subject extraction section 105 shown in FIG. 3 measures a relative color distance in a deformed HSV color space as a Euclidean distance. Thus, it is possible to avoid a problem with color separation performance at low lightness when a cone model or a column model is used, and to reduce the amount of computation compared to a case where a relative color distance is measured in the deformed HSV color space.

[Different Exemplary Configuration of Subject Extraction Section]

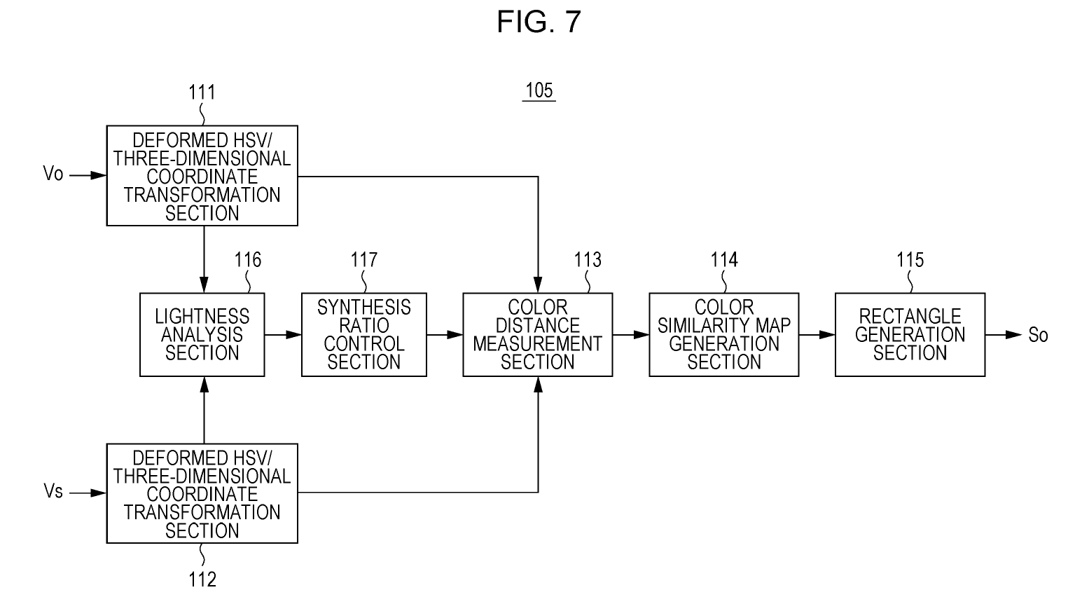

FIG. 7 shows another exemplary configuration of the subject extraction section 105. Components in FIG. 7 corresponding to the components in FIG. 3 are denoted by the same reference symbols to omit detailed description as appropriate. In the exemplary configuration, the color distance measurement section 113 measures a relative color distance d using any of the formula (11), the formula (12), and the formula (13) given above.

The subject extraction section 105 includes the deformed HSV/three-dimensional coordinate transformation sections 111 and 112, the color distance measurement section 113, the color similarity map generation section 114, and the rectangle generation section 115. The subject extraction section 105 further includes a lightness analysis section 116 and a synthesis ratio control section 117. The lightness analysis section 116 calculates average lightness B0 for the pixel data of the image signal Vo obtained by the imaging section 102 (see FIG. 1) by capturing an image. The lightness analysis section 116 also calculates lightness B1 for the pixel data Vs around the touch point.

The synthesis ratio control section 117 controls the weight wv for the lightness V component and the weight ws for the hue H and saturation S components, which are to be used by the color distance measurement section 113, on the basis of the lightnesses B0 and B1 calculated by the lightness analysis section 116 as indicated by the following formulas (16):

ws=1−α

wv=α

where α=|B0−B1|/255 (16)

That is, the synthesis ratio control section 117 calculates α=|B0 −B1|/255, and controls the weight wv for the lightness V component to wv=α, and controls the weight ws for the hue H and saturation S components to ws=1−α. If the difference between B0 and B1 is small, it is assumed that the lightness of the color for an area around the touch point is close to the lightness of the background color, and that it is difficult to separate the color for the area around the touch point from the background color on the basis of the color distance based on the lightness component. Therefore, the synthesis ratio control section 117 controls the weights wv and ws as discussed above to increase the rate of contribution of the color distance based on the hue and saturation components.

The other components of the subject extraction section 105 shown in FIG. 7 are the same as the corresponding components of the subject extraction section 105 shown in FIG. 3, and operate in the same manner.

As discussed above, the subject extraction section 105 shown in FIG. 7 measures a relative color distance in a deformed HSV color space as a Euclidean distance as with the subject extraction section 105 shown in FIG. 3. Therefore, it is possible to avoid a problem with color separation performance at low lightness when a cone model or a column model is used, and to reduce the amount of computation compared to a case where a relative color distance is measured in the deformed HSV color space.

In addition, in calculating a relative color distance, the weight wv for the lightness V component and the weight ws for the hue H and saturation S components are controlled on the basis of the difference between the average lightness B0 for the pixel data forming the image signal Vo and the lightness B1 for the pixel data Vs around the touch point. That is, if the lightness of the color for an area around the touch point and the lightness of the background color are close to each other, the rate of contribution of the color distance based on the hue and saturation components is increased to enable separation between the color for the area around the touch point and the background color on the basis of the relative color distance.

### 2. Modification

In the embodiment discussed above, the color similarity map generation section 114 normalizes the relative color distance di measured by the color distance measurement section 113 into data from 0 to 255, and further reverses the normalized data di′ to generate color similarity map data di″. However, the normalized data di′ are not necessarily reversed, and the normalized data di′ may be supplied as they are to the rectangle generation section 115 so that the rectangle generation section 115 generates a frame display signal So on the basis of the normalized data di′.

The present technology may be configured as follows.

(1) A color distance measurement apparatus including: a first transformation section that transforms first color pixel data and second color pixel data in a predetermined color space into a deformed HSV color space; a second transformation section that transforms the first color pixel data and the second color pixel data, which have been transformed into the deformed HSV color space, into a three-dimensional x, y, z coordinate representation; and a color distance measurement section that measures a relative color distance between the first color pixel data and the second color pixel data on the basis of the first color pixel data and the second color pixel data which have been transformed into the x, y, z coordinate representation, in which in the deformed HSV color space, a maximum value of saturation is larger than a maximum value of saturation in an HSV color space for a cone model at lightness between maximum lightness and minimum lightness, and the saturation is 0 at the minimum lightness.

(2) The color distance measurement apparatus according to (1) above, in which the maximum value of the saturation at each lightness in the deformed HSV color space is determined such that a color distance between two colors having different saturations at the same lightness measured in the deformed HSV color space is equal to a color distance between the two colors measured in an LAB color space.

(3) The color distance measurement apparatus according to (1) or (2) above, further including: a control section that controls a synthesis ratio at which the color distance measurement section mixes a distance based on hue and saturation components and a distance based on a lightness component.

(4) The color distance measurement apparatus according to (3) above, in which the first color pixel data include pixel data on a specific pixel forming an image, and the second color pixel data include pixel data on an arbitrary pixel forming the image, and the control section controls the synthesis ratio on the basis of average lightness for the image and lightness for an area around the specific pixel.

(5) The color distance measurement apparatus according to (4) above, in which the image is an image captured by an imaging element.

(6) The color distance measurement apparatus according to any one of (1) to (5) above, further including: a data table that stores a maximum value of saturation at predetermined sampling points of lightness in the deformed HSV color space, in which the first transformation section transforms the first color pixel data and the second color pixel data in the predetermined color space into the deformed HSV color space using the data table.

(7) A color distance measurement method including: transforming first color pixel data and second color pixel data in a predetermined color space into a deformed HSV color space; transforming the first color pixel data and the second color pixel data, which have been transformed into the deformed HSV color space, into a three-dimensional x, y, z coordinate representation; and measuring a relative color distance between the first color pixel data and the second color pixel data on the basis of the first color pixel data and the second color pixel data which have been transformed into the x, y, z coordinate representation, in which in the deformed HSV color space, a maximum value of saturation is larger than a maximum value of saturation in an HSV color space for a cone model at lightness between maximum lightness and minimum lightness, and the saturation is 0 at the minimum lightness.

(8) A program that causes a computer to function as: first transformation means for transforming first color pixel data and second color pixel data in a predetermined color space into a deformed HSV color space; second transformation means for transforming the first color pixel data and the second color pixel data, which have been transformed into the deformed HSV color space, into a three-dimensional x, y, z coordinate representation; and color distance measurement means for measuring a relative color distance between the first color pixel data and the second color pixel data on the basis of the first color pixel data and the second color pixel data which have been transformed into the x, y, z coordinate representation, in which in the deformed HSV color space, a maximum value of saturation is larger than a maximum value of saturation in an HSV color space for a cone model at lightness between maximum lightness and minimum lightness, and the saturation is 0 at the minimum lightness.

The present disclosure contains subject matter related to that disclosed in Japanese Priority Patent Application JP 2012-056602 filed in the Japan Patent Office on Mar. 14, 2012, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A color distance measurement apparatus comprising:
a first transformation section that transforms first color pixel data and second color pixel data in a predetermined color space into a deformed HSV color space;
a second transformation section that transforms the first color pixel data and the second color pixel data, which have been transformed into the deformed HSV color space, into a three-dimensional x, y, z coordinate representation; and
a color distance measurement section that measures a relative color distance between the first color pixel data and the second color pixel data on the basis of the first color pixel data and the second color pixel data which have been transformed into the x, y, z coordinate representation,
wherein in the deformed HSV color space, a maximum value of saturation is larger than a maximum value of saturation in an HSV color space for a cone model at lightness between maximum lightness and minimum lightness, and the saturation is 0 at the minimum lightness.

2. The color distance measurement apparatus according to claim 1,
wherein the maximum value of the saturation at each lightness in the deformed HSV color space is determined such that a color distance between two colors having different saturations at the same lightness measured in the deformed HSV color space is equal to a color distance between the two colors measured in an LAB color space.

3. The color distance measurement apparatus according to claim 1, further comprising:
a control section that controls a synthesis ratio at which the color distance measurement section mixes a distance based on hue and saturation components and a distance based on a lightness component.

4. The color distance measurement apparatus according to claim 3,
wherein the first color pixel data include pixel data on a specific pixel forming an image, and the second color pixel data include pixel data on an arbitrary pixel forming the image, and
the control section controls the synthesis ratio on the basis of average lightness for the image and lightness for an area around the specific pixel.

5. The color distance measurement apparatus according to claim 4,
wherein the image is an image captured by an imaging element.

6. The color distance measurement apparatus according to claim 1, further comprising:
a data table that stores a maximum value of saturation at predetermined sampling points of lightness in the deformed HSV color space,
wherein the first transformation section transforms the first color pixel data and the second color pixel data in the predetermined color space into the deformed HSV color space using the data table.

7. A color distance measurement method comprising:
transforming first color pixel data and second color pixel data in a predetermined color space into a deformed HSV color space;
transforming the first color pixel data and the second color pixel data, which have been transformed into the deformed HSV color space, into a three-dimensional x, y, z coordinate representation; and
measuring a relative color distance between the first color pixel data and the second color pixel data on the basis of the first color pixel data and the second color pixel data which have been transformed into the x, y, z coordinate representation,
wherein in the deformed HSV color space, a maximum value of saturation is larger than a maximum value of saturation in an HSV color space for a cone model at lightness between maximum lightness and minimum lightness, and the saturation is 0 at the minimum lightness.

8. A program that causes a computer to function as:
first transformation means for transforming first color pixel data and second color pixel data in a predetermined color space into a deformed HSV color space;
second transformation means for transforming the first color pixel data and the second color pixel data, which have been transformed into the deformed HSV color space, into a three-dimensional x, y, z coordinate representation; and
color distance measurement means for measuring a relative color distance between the first color pixel data and the second color pixel data on the basis of the first color pixel data and the second color pixel data which have been transformed into the x, y, z coordinate representation,
wherein in the deformed HSV color space, a maximum value of saturation is larger than a maximum value of saturation in an HSV color space for a cone model at lightness between maximum lightness and minimum lightness, and the saturation is 0 at the minimum lightness.
